(19) United States
(12) Patent Application Publication
(10) Pub. No.: US 2013/0335645 A1
(43) Pub. Date: Dec. 19, 2013

(54) PHOTOSENSITIVE RESIN COMPOSITION AND APPLICATION OF THE SAME

(71) Applicant: Chi Mei Corporation, Tainan City (TW)

(72) Inventors: Chia-Hui YU, Puzih City (TW); Chih-Hung LIN, Tainan City (TW)

(21) Appl. No.: 13/920,122

(22) Filed: Jun. 18, 2013

(30) Foreign Application Priority Data
Jun. 19, 2012 (TW) 101121897

(51) Int. Cl. G02F 1/1333

(52) U.S. Cl. CPC G02F 1/13338
USPC 349/12; 522/123; 522/120

(57) ABSTRACT

A photosensitive resin composition includes (A) a conjugated diene polymer having a (meth)acryloyl group, (B) a compound having at least one ethylenically unsaturated group, (C) a photo-initiator, and (D) a compound represented by formula (I):

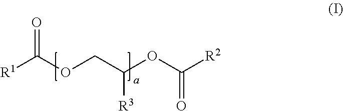

where R¹ and R² independently represent a C₁-C₂₀ alkyl group or a C₁-C₂₀ aryl group, R³ represents hydrogen or methyl, and a is an integer ranging from 2 to 20.

### CROSS-REFERENCE TO RELATED APPLICATION

This application claims priority of Taiwanese Application No. 101121897, filed on Jun. 19, 2012.

### BACKGROUND OF THE INVENTION

1. Field of the Invention

The present invention relates to a photosensitive resin composition, and more particularly to a photosensitive resin composition having improved impact resistance after being cured. This invention also relates to an adhesive layer obtained from the photosensitive resin composition, and a touch display device including the adhesive layer.

2. Description of the Related Art

In general, an image display device includes a display unit, and a transparent panel (for example, a protective sheet or a touch panel, etc.) disposed on the display unit. There is usually a gap formed between the display unit and the transparent panel. If air exists in the gap, a reflection phenomenon occurs due to the difference between the refraction index of air and that of the transparent panel, resulting in the reduction of the light transmittance. Currently, in order to solve this problem, resin compositions are filled in the gap so that the panel and the display unit can be firmly adhered to each other. In addition, when the panel is compressed, the resin compositions may provide a buffering effect. Because the resin compositions can provide both adhesion and buffering effects, the resin compositions applied between the display unit and the panel must not only have transparency and adhesion properties, but also specific properties (for example, mechanical properties, optical properties, etc.) in cooperation with the display unit and the panel.

The resin compositions are generally classified into thermo-curing type resin compositions, photo-curing type resin compositions, and photo-thermo-curing type resin compositions. Because some of the display elements (for example, electroluminescent (EL) devices) have a heat resistant temperature ranging from about 80 to 120° C. and the thermal resistance therefore is insufficient, the curing process for the thermo-curing type resin compositions may cause damage to the display elements. Therefore, photo-curing type resin compositions are mostly selected for the display elements.

Japanese Patent Publication No. 2009-186963 discloses a resin composition, which comprises a polymer, a monomer and a photo-polymerization initiator. The polymer is selected from a polyurethane acrylate, a hydrogenated terpene resin, a butadiene polymer, and a polyisoprene acrylate, or esters thereof. The monomer is selected from acrylate monomers, for example, isobornyl acrylate and 2-hydroxylbutyl 2-methyl-2-acrylate. The photo-polymerization initiator is selected from 1-hydroxycyclohexyl-phenyl-ketone and 2,4,6-trimethyl benzoyl diphenyl phosphine oxide. Although the resin composition is suitable for an image display device, it is still desirable to improve the impact resistance of the resin composition after being cured.

It is desirable to develop a resin composition which is suitable for forming an adhesive layer between a display unit and a transparent panel, and which has ideal mechanical properties, especially the impact resistance, after being cured.

### SUMMARY OF THE INVENTION

Therefore, a first object of the present invention is to provide a photosensitive resin composition having good impact resistance after being cured.

A second object of the present invention is to provide an adhesive layer obtained from the photosensitive resin composition.

A third object of the present invention is to provide a touch display device including the adhesive layer.

According to a first aspect of this invention, there is provided a photosensitive resin composition which includes (A) a conjugated diene polymer having a (meth)acryloyl group, (B) a compound having at least one ethylenically unsaturated group, (C) a photo-initiator, and (D) a compound represented by formula (I):

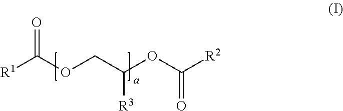

where R¹ and R² independently represent a C₁-C₂₀ alkyl group or a C₁-C₂₀ aryl group, R³ represents hydrogen or methyl, and a is an integer ranging from 2 to 20.

According to a second aspect of this invention, there is provided an adhesive layer obtained from the photosensitive resin composition.

According to a third aspect of this invention, there is provided a touch display device including the adhesive layer.

### DETAILED DESCRIPTION OF THE PREFERRED EMBODIMENTS

First, as used herein, the term “(meth)acrylate” means acrylate and/or methacrylate.

A photosensitive resin composition of the present invention includes (A) a conjugated diene polymer having a (meth)acryloyl group, (B) a compound having at least one ethylenically unsaturated group, (C) a photo-initiator, and (D) a compound represented by formula (I):

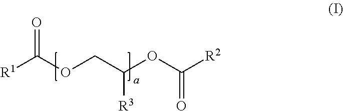

where R¹ and R² independently represent a C₁-C₂₀ alkyl group or a C₁-C₂₀ aryl group, R³ represents hydrogen or methyl, and a is an integer ranging from 2 to 20.

### (A) Conjugated Diene Polymer Having a (Meth)Acryloyl Group:

The method for manufacturing the conjugated diene polymer having a (meth)acryloyl group is not particularly limited. For example, the conjugated diene polymer having a (meth)acryloyl group can be manufactured through the following steps (a) to (c):

(a) A conjugated diene monomer is dissolved in a solvent. An anionic polymerization is conducted using sec-butyl lithium as an initiator to obtain a conjugated diene polymer having a repeating unit of the following formula:

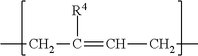

where R⁴ represents hydrogen or methyl;

(b) The conjugated diene polymer thus obtained and maleic anhydride are mixed in a solvent. Polymerization is conducted at a temperature ranging from 85° C., to 100° C. so as to graft maleic anhydride onto the conjugated diene polymer. A maleic-anhydride-modified conjugated diene polymer having repeating units of formulas (N) and (M) is obtained accordingly:

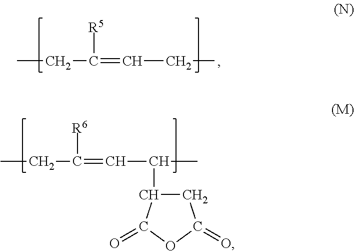

where R⁵ and R⁶ individually represent hydrogen or methyl, N is a number ranging from 1 to 20000, and M is a number ranging from 1 to 4000; and

(c) The maleic-anhydride-modified conjugated diene polymer thus obtained is mixed with a (meth)acrylic acid monomer containing a hydroxyl group in a solvent, and a half-esterification reaction is performed by adding hydroquinone and N,N-dimethylbenzylamine as catalysts to obtain a conjugated diene polymer containing a (meth)acryloyl group and having repeating units of formulas (N1) and (M1):

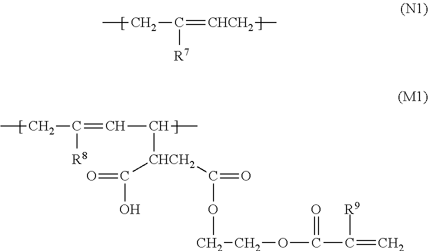

where R⁷, R⁸ and R⁹ individually represent hydrogen or methyl, N1 is a number ranging from 1 to 20000, and M1 is a number ranging from 1 to 4000.

Examples of the conjugated diene monomer include, but are not limited to, 1,3-butadiene, 2-methyl-1,3-butadiene, 2,3-dimethyl-1,3-butadiene, 1,3-pentadiene, and 1,3-hexadiene. These examples may be used alone or in admixture of two or more thereof. Preferably, the conjugated diene monomer is 1,3-butadiene or 2-methyl-1,3-butadiene.

Preferably, the (meth)acrylic acid monomer containing a hydroxyl group used in step (c) is a monomer selected from the group consisting of 2-hydroxyethyl (meth)acrylate, 2-hydroxypropyl (meth)acrylate, 3-hydroxypropyl (meth)acrylate, pentaerythritol tri(meth)acrylate, and dipentaerythritol hexa (meth)acrylate. More preferably, the (meth)acrylic acid monomer containing a hydroxyl group is 2-hydroxyethyl (meth)acrylate or pentaerythritol tri(meth)acrylate.

### (B) Compound Having at Least One Ethylenically Unsaturated Group:

Examples of the compound having at least one ethylenically unsaturated group include, but are not limited to, a compound having one (meth)acrylate group, a compound having two or more (meth)acrylate groups, or a combination thereof.

Examples of the compound having one (meth)acrylate group include, but are not limited to, acrylamide, (meth)acryloylmorpholine, 7-amino-3,7-dimethyloctyl (meth)acrylate, isobutoxymethyl(meth)acrylamide, isobornyloxyethyl (meth)acrylate, isobornyl (meth)acrylate, 2-ethylhexyl (meth)acrylate, ethyl diethylene glycol(meth)acrylate, t-octyl(meth)acrylamide, diacetone(meth)acrylamide, dimethylaminoethyl (meth)acrylate, dodecyl(meth)acrylate, dicyclopentenyloxyethyl (meth)acrylate, dicyclopentenyl (meth)acrylate, N,N-dimethyl(meth)acrylamide, tetrachlorophenyl (meth)acrylate, 2-tetrachlorophenoxy ethyl (meth)acrylate, tetrahydrofurfuryl (meth)acrylate, tetrabromophenyl (meth)acrylate, 2-tetrabromophenoxyethyl (meth)acrylate, 2-trichlorophenoxyethyl (meth)acrylate, tribromophenyl (meth)acrylate, 2-tribromophenoxyethyl (meth)acrylate, 2-hydroxyethyl (meth)acrylate, 2-hydroxypropyl (meth)acrylate, vinylcaprolactam, N-vinylpyrrolidone, phenoxyethyl (meth)acrylate, pentachlorophenyl (meth)acrylate, pentabromophenyl (meth)acrylate, polyethylene glycol mono (meth)acrylate, polypropylene glycol mono (meth)acrylate, and bornyl (meth)acrylate.

Examples of the compound having two or more (meth)acrylate groups include, but are not limited to, ethylene glycol di(meth)acrylate, dicyclopentenyl di(meth)acrylate, triethylene glycol diacrylate, tetraethylene glycol di(meth)acrylate, tri(2-hydroxyethyl)isocyanate di(meth)acrylate, tri(2-hydroxyethyl)isocyanate tri(meth)acrylate, caprolactone-modified tri(2-hydroxyethyl)isocyanate tri(meth)acrylate, trihydroxymethylpropyl tri(meth)acrylate, ethylene oxide (hereinafter abbreviated as EO) modified trihydroxymethylpropyl tri(meth)acrylate, propylene oxide (hereinafter abbreviated as PO) modified trihydroxymethylpropyl tri(meth)acrylate, triethylene glycol di(meth)acrylate, neopentyl glycol di(meth)acrylate, 1,4-butanediol di(meth)acrylate, 1,6-hexanediol di(meth)acrylate, pentaerythritol tri(meth)acrylate, pentaerythritol tetra(meth)acrylate, polyester di(meth)acrylate, polyethylene glycol di(meth)acrylate, dipentaerythritol hexa(meth)acrylate, dipentaerythritol penta(meth)acrylate, dipentaerythritol tetra(meth)acrylate, caprolactone-modified dipentaerythritol hexa(meth)acrylate, caprolactone-modified dipentaerythritol penta(meth)acrylate, ditrimethylolpropyl tetra(meth)acrylate, EO-modified bisphenol A di(meth)acrylate, PO-modified bisphenol A di(meth)acrylate, EO-modified hydrogenated bisphenol A di(meth)acrylate, PO-modified hydrogenated bisphenol A di (meth)acrylate, PO-modified glycerol triacrylate, EO-modified bisphenol F di(meth)acrylate, and phenol novolac polyglycidyl ether (meth)acrylate.

Preferably, the compound having at least one ethylenically unsaturated group is at least one compound selected from the group consisting of dicyclopentenyloxyethyl acrylate, 2-hydroxyethyl methacrylate, isobornyl acrylate, isobornyl methacrylate, trihydroxymethylpropyl triacrylate, EO-modified trihydroxymethylpropyl triacrylate, PO-modified trihydroxymethylpropyl triacrylate, pentaerythritol triacrylate, pentaerythritol tetraacrylate, dipentaerythritol hexaacrylate, dipentaerythritol pentaacrylate, dipentaerythritol tetraacrylate, caprolactone-modified dipentaerythritol hexaacrylate, ditrimethylolpropyl tetra(meth)acrylate, and PO— modified glycerol triacrylate.

The compound having at least one ethylenically unsaturated group is used in an amount ranging preferably from 20 to 100 parts by weight, more preferably from 30 to 90 parts by weight, and even more preferably from 30 to 80 parts by weight based on 100 parts by weight of the conjugated diene polymer having a (meth)acryloyl group (A).

### (C) Photo-Initiator:

Examples of the photo-initiator suitable for the present invention include, but are not limited to, acetophenone compounds, phenyl ketone compounds, biimidazole compounds, acyl oxime compounds, acylphosphine oxide compounds, and combinations thereof.

Examples of the acetophenone compounds include, but are not limited to, p-dimethylamino-acetophenone, α,α′-dimethoxyazoxy-acetophenone, 2,2′-dimethyl-2-phenyl-acetophenone, p-methoxy-acetophenone, 2-methyl-1-(4-methylthiophenyl)-2-morpholino-1-propanone, and 2-benzyl-2-N,N-dimethylamino-1-(4-morpholinophenyl)-1-butanone.

Examples of the phenyl ketone compounds include, but are not limited to, 1-hydroxycyclohexyl-phenyl-ketone (trade name: Irgacure 184, manufactured by Ciba Specialty Chemicals Co.), 2-hydroxy-2-methyl-1-phenyl-propane-1-one (trade name: DAROCUR 1173, manufactured by Ciba Specialty Chemicals Co.), and 2-hydroxy-1-{4-[4-(2-hydroxy-2-methyl-propionyl)benzyl]phenyl}-2-methyl-propane-1-one (trade name: IRGACURE 127, manufactured by Ciba Specialty Chemicals Co.).

Examples of the biimidazole compounds include, but are not limited to, 2,2′-bis(o-chlorophenyl)-4,4′,5,5′-tetraphenyl-biimidazole, 2,2′-bis(o-fluorophenyl)-4,4′,5,5′-tetraphenyl-biimidazole, 2,2′-bis(o-methyl phenyl)-4,4′,5,5′-tetraphenyl-biimidazole, 2,2′-bis(o-methoxyphenyl)-4,4′,5,5′-tetraphenyl-biimidazole, 2,2′-bis(o-ethylphenyl)-4,4′,5,5′-tetraphenyl-biimidazole, 2,2′-bis(p-methoxyphenyl)-4,4′,5,5′-tetraphenyl-biimidazole, 2,2′-bis(2,2′,4,4′-tetramethoxyphenyl)-4,4′,5,5′-tetraphenyl-biimidazole, 2,2′-bis(2-chlorophenyl)-4,4′,5,5′-tetraphenyl-biimidazole, and 2,2′-bis(2,4-dichlorophenyl)-4,4′,5,5′-tetraphenyl-biimidazole.

Examples of the acyl oxime compounds include, but are not limited to, ethanone, 1-[9-ethyl-6-(2-methylbenzoyl)-9H-carbazole-3-yl]-, 1-(O-acetyloxime) (trade name: CGI-242, manufactured by Ciba Specialty Chemicals Co.), 1-(4-phenyl-thio-phenyl)-octane-1,2-dion 2-oxime-O-benzoate (trade name: CGI-124, manufactured by Ciba Specialty Chemicals Co.), and ethanone, 1-[9-ethyl-6-(2-chloro-4-benzyl-thio-benzoyl)-9H-carbazole-3-yl]-, 1-(O-acetyl oxime) (manufactured by ADEKA Co.).

Examples of the acylphosphine oxide compounds include, but are not limited to, 2,4,6-trimethyl benzoyl diphenyl phosphine oxide (trade name: TPO, manufactured by Ciba Specialty Chemicals Co.) and bis-(2,6-dimethoxyl benzoyl)-2,4,4-trimethylbenzyl phosphine oxide.

Preferably, the photo-initiator is at least one compound selected from the group consisting of p-dimethylamino-acetophenone, 1-hydroxycyclohexyl-phenyl-ketone, 2-hydroxy-2-methyl-1-phenyl-propane-1-one, and 2,4,6-trimethyl benzoyl diphenyl phosphine oxide.

The photo-initiator is used in an amount ranging preferably from 2 to 40 parts by weight, more preferably from 3 to 35 parts by weight, and even more preferably from 5 to 30 parts by weight based on 100 parts by weight of the compound having at least one ethylenically unsaturated group.

### (D) Compound Represented by Formula (I):

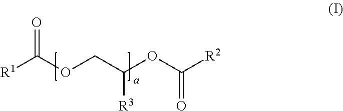

where R¹ and R² independently represent a C₁-C₂₀ alkyl group or a C₁-C₂₀ aryl group, R³ represents hydrogen or methyl, and a is an integer ranging from 2 to 20.

Examples of the compound represented by formula (I) include, but are not limited to, diethylene glycol di-2-ethylhexanoate, triethylene glycol di-2-ethylhexanoate, tetraethylene glycol di-2-ethylhexanoate, polyethylene glycol di-2-ethylhexanoate, triethylene glycol diethylbutylate, polyethylene glycol diethylbutylate, polypropylene glycol diethyl hexanoate, triethylene glycol dibenzoate, polyethylene glycol dibenzoate, polypropylene glycol dibenzoate, and polyethylene glycol-2-ethylhexanoate benzoate. The aforesaid examples may be used alone or in admixture of two or more thereof.

Preferably, the compound represented by formula (I) is a compound selected from the group consisting of diethylene glycol di-2-ethylhexanoate, tetraethylene glycol di-2-ethylhexanoate, dipropylene glycol dibenzoate, triethylene glycol dibenzoate, polyethylene glycol dibenzoate, and combinations thereof.

When the compound represented by formula (I) is not added, the photosensitive resin composition suffers from a poor impact resistance. The compound represented by formula (I) is used in an amount ranging preferably from 1 to 12 parts by weight, more preferably from 2 to 11 parts by weight, and even more preferably from 3 to 10 parts by weight based on 100 parts by weight of the conjugated diene polymer having a (meth)acryloyl group.

### (E) Hydrogenated Terpene Resin:

Preferably, the photosensitive resin composition further comprises a hydrogenated terpene resin that further facilitates the impact resistance of the photosensitive resin composition. Commercially available examples of the hydrogenated terpene resin suitable for the present invention include, but are not limited to, Clearon P-85, Clearon M-115, Clearon M-105, Clearon P-125, Clearon P-115, and Clearon P-105 from YASUHARA CHEMICAL Co.

### (F) Other Additives:

In addition to the aforesaid components (A), (B), (C), and (D), various additives, such as sensitizer, surfactant, defoaming agents, solubilizer, etc., may be added into the photosensitive resin composition, if necessary.

Preferably, the photosensitive resin composition has a shore hardness value ranging from 3 to 12 after curing. The shore hardness value in this range can further increase the impact resistance of the photosensitive resin composition after curing. The shore hardness value of the photosensitive resin composition after curing ranges more preferably from 3 to 11 and even more preferably from 3 to 10.

An adhesive layer is obtained by curing the photosensitive resin composition. Preferably, the photosensitive resin composition is cured using light irradiation. More preferably, the light for the irradiation is selected from ultraviolet lights of g-line, h-line, i-line or the like. More preferably, examples of the device for the light irradiation include, but are not limited to, a high pressure mercury lamp, a ultra-high pressure mercury lamp, and a metal halide lamp.

A touch display device of the present invention comprises a touch unit, a liquid crystal display unit, and the adhesive layer as mentioned above. The adhesive layer is disposed between the touch unit and the liquid crystal display unit.

The adhesive layer that is disposed between the touch unit and the liquid crystal display unit can reduce the scattering of the light that is produced at the interface between the resin composition and the touch unit and/or the interface between the resin composition and the liquid crystal display unit, and increase the brightness of the displayed image, thereby enhancing effectively the display quality.

The following examples are provided to illustrate the preferred embodiments of the invention, and should not be construed as limiting the scope of the invention.

### EXAMPLES

### Synthesis of Conjugated Diene Polymer Having a (Meth)acryloyl Group

### Synthesis Example A-1

A 1000 ml four-necked flask equipped with a nitrogen inlet, a stirrer, a heater, a condenser, and a thermometer was introduced with nitrogen and was added with polyisoprene-grafted maleic anhydride (Trade Name: 460060, weight average molecular weight: 25,000, manufactured by Sigma-Aldrich, 100 parts by weight), 2-hydroxyethyl methacrylate (4.5 part by weight), pentaerythritol trimethacrylate (4.5 parts by weight), hydroquinone (0.1 part by weight), N,N-dimethylbenzylamine (1.5 parts by weight), and n-hexane (2 parts by weight, as a solvent). A polymerization reaction was conducted for 3 hours at a temperature of 80° C. After the polymerization reaction was completed, the product thus obtained was taken out of the flask, followed by devolatilizing the solvent, thereby obtaining a conjugated diene polymer having a (meth)acryloyl group (A-1).

### Synthesis Examples A-2 to A-7

Synthesis Examples A-2 to A-7 were conducted in a manner identical to that of Synthesis Example 1 using the components and the amounts thereof shown in Table 1 so as to obtain polymers A-2 to A-7.

### Preparation of Photosensitive Resin Compositions

### Example 1

Polymer A-1 (100 parts by weight), dicyclopentenyloxyethyl acrylate (hereinafter referred to as B-1, 45 parts by weight), Irgacure 184 (manufactured by Ciba Specialty Chemicals, hereinafter referred to as C-1, 10 parts by weight), and dipropylene glycol dibenzoate (hereinafter referred to as D-1, 5 parts by weight) were mixed together to obtain a photosensitive resin composition. The photosensitive resin composition thus obtained was evaluated according to the following evaluation methods. The evaluation results are shown in Table 2.

### Examples 2 to 7

Examples 2 to 7 were conducted in a manner identical to that of Example 1 using the components and the amounts thereof shown in Table 2. In Examples 2 and 7, hydrogenated terpene resins are further added. The obtained photosensitive resin compositions of Examples to 7 were evaluated according to the following evaluation methods. The evaluation results are shown in Table 2.

### Comparative Examples 1 to 3

Comparative Examples 1 to 3 were conducted in a manner identical to that of Example 1 using the components and the amounts thereof shown in Table 2. Specifically, the compound represented by formula (I) was not added in Comparative Examples 1 to 3. The obtained photosensitive resin compositions of Comparative Examples 1 to 3 were evaluated according to the following evaluation methods. The evaluation results are shown in Table 2.

### Comparative Example 4

Comparative Example 4 was formulated according to Example 1 of Japanese Patent Publication No. 2009-18963. Specifically, a maleic-anhydride-modified conjugated diene polymer (trade name: UC-203, manufactured by Kuraray, 55 parts by weight), dicyclopentenyloxyethyl methacrylate (trade name: FA512M, manufactured by HITACHI CHEMICAL, 40 parts by weight), 2-hydroxyethyl methacrylate (trade name: Light Ester HOB, manufactured by Kyoeisha Chemical Co. Ltd., 10 parts by weight), a hydrogenated terpene resin (trade name: Clearon P-85, manufactured by YASUHARA CHEMICAL Co., 60 parts by weight), polybutadiene (trade name: Polyoil 110, manufactured by ZEON, 80 parts by weight), and photoinitiators (trade name: Irgacure 184, manufactured by Ciba Specialty Chemicals, 6 parts by weight, and trade name: SpeedCure TPO, manufactured by SiberHegner, 1.5 parts by weight) were mixed together to obtain a photosensitive resin composition. The photosensitive resin composition thus obtained was evaluated according to the following evaluation methods. The evaluated impact resistance was determined as “X.”

### Evaluation Items:

### 1. Shore Hardness:

Each of the photosensitive resin compositions obtained in Examples 1-7 and Comparative Examples 1-4 was injected into a mold, and was cured by irradiating with ultraviolet light (illumination intensity: 100 mW/cm², exposure time: 30 seconds) to obtain a 40 mm×80 mm×120 mm hard block. Next, a rubber hardness tester (model No.: GS-721N, manufactured by TECLOCK Co.) was placed in contact with the hard block for 3 seconds to measure the shore hardness value (no unit) of the hard block.

### 2. Impact Resistance

Each of the photosensitive resin compositions obtained in Examples 1-7 and Comparative Examples 1-4 was applied between two plates of glass (20 mm×50 mm), and was irradiated with ultraviolet light (illumination intensity: 100 mW/cm², exposure time: 50 seconds) to form a cured resin layer having a thickness of 0.1 mm. Next, one of the glass plates was depressed by a jig of a tension machine (model No. AI-7000S, manufactured by GOTECH Co.), at a depression speed of 1 mm/sec at a contact face of the jig and the glass plates that has a diameter of 3 mm until the glass plates fractured, followed by recording the maximum force value.

⊚: maximum force value ≧35N

◯: 35N>maximum force value ≧30N

Δ: 30N>maximum force value ≧20N

X: maximum force value <20N

TABLE 1
Composition (parts by weight)

| | Conjugated | | | | | | |
|---|---|---|---|---|---|---|---|
| | diene | | | | | | |
| Synthesis | polymer | Monomer | | Catalyst | | Solvent | |
| Examples | 460060 | HEMA | PTMA | HQ | DMBA | CH | TOL |
| A-1 | 100 | 4.5 | 4.5 | 0.1 | 1.5 | 2 | — |
| A-2 | 100 | 5.5 | 1 | — | 1.5 | 2 | — |
| A-3 | 100 | — | 8 | 0.1 | 1.2 | 10 | — |
| A-4 | 100 | 4 | 12 | 0.1 | 1.5 | 2 | — |
| A-5 | 100 | 13 | 11 | 0.2 | 1.5 | — | 5 |
| A-6 | 100 | 10 | 10 | 0.1 | 1.5 | 2 | — |
| A-7 | 100 | 18 | — | 0.1 | 1.5 | 2 | 2 |

Note:
┌—┘ means not added

| | |
|---|---|
| Abbreviation | Full name |
| 460060 | polyisoprene-grafted maleic anhydride |
| | (manufactured by Sigma-Aldrich Co.) |
| HEMA | 2-hydroxyethyl methacrylate |
| PTMA | pentaerythritol trimethacrylate |
| HQ | hydroquinone |
| DMBA | N,N-dimethylbenzylamine |
| CH | cyclohexane |
| TOL | toluene |

TABLE 2

| | | | | | | | | | Comparative | | |
|---|---|---|---|---|---|---|---|---|---|---|---|
| | | Examples | | | | | | | Examples | | |
| Composition | | 1 | 2 | 3 | 4 | 5 | 6 | 7 | 1 | 2 | 3 |
| (A) conjugated diene | A-1 | 100 | — | — | — | — | — | — | 100 | — | — |
| polymer having a | A-2 | —^{a} | 100 | — | — | — | — | — | — | 100 | — |
| (meth)acryloyl group | A-3 | — | — | 100 | — | — | — | — | — | — | — |
| (parts by weight) | A-4 | — | — | — | 100 | — | — | — | — | — | — |
| | A-5 | — | — | — | — | 100 | — | — | — | — | — |
| | A-6 | — | — | — | — | — | 100 | — | — | — | — |
| | A-7 | — | — | — | — | — | — | 100 | — | — | 100 |
| (B) compound having | B-1 | 45 | — | 30 | 10 | — | 20 | 15 | 45 | — | 15 |
| at least one | B-2 | — | 10 | — | 5 | 10 | 10 | 15 | — | 10 | 15 |
| ethylenically | B-3 | — | 40 | — | 40 | 10 | — | 20 | — | 40 | 20 |
| unsaturated group | B-4 | — | — | — | — | 30 | 10 | — | — | — | — |
| (parts by weight) | | | | | | | | | | | |
| (C) photo-initiator | C-1 | 10 | — | 10 | 3 | 5 | 20 | — | 10 | — | — |
| (parts by weight) | C-2 | — | 8 | 2 | — | — | — | 15 | — | 8 | 15 |
| (D) compound | D-1 | 5 | 1 | — | — | 3 | 12 | — | — | — | — |
| (parts by weight) | D-2 | — | — | 10 | 2 | — | — | 8 | — | — | — |
| | D-3 | — | — | — | 1 | 3 | — | — | — | — | — |
| (E) hydrogenated | E-1 | — | 3 | — | — | — | — | — | — | 3 | — |
| terpene resin | E-2 | — | — | — | — | — | — | 2 | — | — | 2 |
| (parts by weight) | | | | | | | | | | | |
| Evaluation results | Shore Hardness | 4 | 1 | 2 | 8 | 13 | 12 | 10 | 3 | 1 | 8 |
| | Impact resistance | ⊚ | ⊚ | ◯ | ⊚ | ◯ | ⊚ | ⊚ | X | X | X |

a. ┌—┘ means not added
B-1 Dicyclopentenyloxyethyl acrylate
B-2 2-hydroxyethyl methacrylate
B-3 isobornyl methacrylate
B-4 dipentaerythritol hexamethacrylate
C-1 Irgacure 184 (manufactured by Ciba Specialty Chemicals Co.)
C-2 DAROCUR TPO (manufactured by Ciba Specialty Chemicals Co.)
D-1 dipropylene glycol dibenzoate
D-2 triethylene glycol dibenzoate
D-3 tetraethylene glycol di-2-ethylhexanoate
E-1 Clearon P-85 (manufactured by YASUHARA CHEMICAL Co.)
E-2 Clearon M-115 (manufactured by YASUHARA CHEMICAL Co.)

From the evaluation results of Examples 1 to 7 shown in Table 2, it can be seen that the photosensitive resin compositions have excellent impact resistance after curing by virtue of adding the compound (D) represented by formula (I).

It is noted from the evaluation results of Examples 1, 2, 4, 6 and 7 that each of the photosensitive resin compositions has a shore hardness value ranging from 3 to 12 after curing and provides a better impact resistance.

On the contrary, the photosensitive resin compositions obtained in Comparative Examples 1 to 4 do not contain the compound (D) represented by formula (I), and have poor impact resistance after curing. The adhesive layers and the touch display devices produced from the photosensitive resin compositions have severe physical defects.

To sum up, the photosensitive resin composition of the present invention can have an excellent impact resistance after curing by virtue of addition of the compound (D) represented by formula (I). In addition, the adhesive layer and the touch display device produced from the photosensitive resin composition of the present invention have excellent physical properties.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A photosensitive resin composition, comprising:
(A) a conjugated diene polymer having a (meth)acryloyl group;
(B) a compound having at least one ethylenically unsaturated group;
(C) a photo-initiator; and
(D) a compound represented by formula (I): 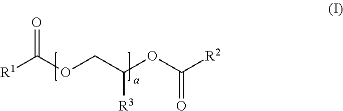
where
R¹ and R² independently represent a C₁-C₂₀ alkyl group or a C₁-C₂₀ aryl group, R³ represents hydrogen or methyl, and a is an integer ranging from 2 to 20.

2. The photosensitive resin composition as claimed in claim 1, wherein said compound represented by formula (I) is in an amount ranging from 1 to 12 parts by weight based on 100 parts by weight of said conjugated diene polymer (A).

3. The photosensitive resin composition as claimed in claim 1, wherein said compound having at least one ethylenically unsaturated group (B) is in an amount ranging from 20 to 100 parts by weight based on 100 parts by weight of said conjugated diene polymer (A).

4. The photosensitive resin composition as claimed in claim 1, wherein said photo-initiator (C) is in an amount ranging from 2 to 40 parts by weight based on 100 parts by weight of said compound having at least one ethylenically unsaturated group (B).

5. The photosensitive resin composition as claimed in claim 1, further comprising a hydrogenated terpene resin.

6. The photosensitive resin composition as claimed in claim 1, having a shore hardness value ranging from 3 to 12 after curing.

7. An adhesive layer obtained by curing the photosensitive resin composition as claimed in claim 1.

8. A touch display device, comprising a touch unit, a liquid crystal display unit, and the adhesive layer as claimed in claim 7, wherein said adhesive layer is disposed between said touch unit and said liquid crystal display unit.
